(19) United States
(12) Patent Application Publication
(10) Pub. No.: US 2012/0257560 A1
(43) Pub. Date: Oct. 11, 2012

(54) Cellular data bandwidth optimization using social networking concepts

(76) Inventors: Sudharshan Srinivasan, Fremont, CA (US); Kothandraman Ramchandran, Fremont, CA (US); Jai Kumar, Cupertino, CA (US)

(21) Appl. No.: 13/066,156

(22) Filed: Apr. 7, 2011

(51) Int. Cl. H04H 20/71; H04W 4/00

(52) U.S. Cl. 370/312; 370/328

(57) ABSTRACT

A bandwidth optimization system to optimize bandwidth usage of a cellular data network is described. This is achieved by organizing data at interactive content cache server (42) such that data and corresponding meta data about said data can be viewed and interacted with by mobile device (32) users. This enables users to download alternate content associated with other users that may be related to their interest thereby improving the cache hit rate exponentially.

### CROSS-REFERENCE TO RELATED APPLICATIONS

Not applicable

### FEDERALLY SPONSORED RESEARCH

Not applicable

### SEQUENCE LISTING OR PROGRAM

Not applicable

### BACKGROUND OF THE INVENTION

1. Column of Invention

The present invention generally relates to bandwidth optimization systems in cellular networks and specifically to bandwidth optimization system using social networking concepts.

2. Prior Art US Patent

There are two kinds of bandwidth optimization systems in prior art. One improves backhaul bandwidth usage and the other improves air interface bandwidth usage. Backhaul bandwidth is improved using compression technologies and caching technologies. Air interface bandwidth is improved using newer modulation techniques.

The present invention describes methods that improve both air interface bandwidth usage and backhaul bandwidth usage using improved caching methods based on social networking concepts at the base station controller in a cellular network.

Prior art caching methods at a base station controller in a cellular network store previously requested data for a period of time or pre-fetch data based on user requests expecting high reuse of fetched data. But such methods are of limited use as the number of cache hits is very low due to varied interests of users and their corresponding requests that may span billions of web pages.

A base station controller in a cellular network is connected to several base transceiver stations that transmit and receive wireless signals. Each base transceiver station controls a geographical area called a cell site. In each cell site there may be several users who may be requesting data from the internet. Since each user request is provided a separate data stream, there is no way for data from one data stream to be reused in another data stream from another user. Hence it can be seen that a single base station controller that controls several base transceiver stations may be serving thousands of users using independent data streams thereby consuming precious bandwidth both in air interface and backhaul network.

In most prior art systems, each user is provided a separate data stream starting from a mobile device using the air interface to the base transceiver station, to the base station controller, to the mobile switching center that is connected to the internet.

In all such prior art systems, there are two points of data bottleneck, one in the backhaul network that connects the base station controller to the mobile switching center, and the other at the air interface where limited availability of spectrum causes excessive congestion in densely populated urban areas.

Upgrade costs of either the backhaul network or using newer modulation techniques for upgrading the air interface can cost several billion dollars. Hence there is a need for optimization methods that better utilize the available bandwidth at both the backhaul network and the air interface while providing reasonable user experience at lower costs.

Prior art caching methods cannot provide high cache hit rate since the intersection of user interest is minimal. Prior art compression methods have reached a limit especially in regards to compressing images and video data. The state of the art compression methods for images are provided by a standards body named joint photographers experts group (jpeg) that provides the jpeg image format. This standard has been in use for several years and there is no new compression algorithm that has been invented to replace this standard. Similarly motion picture experts group (mpeg) provides mpeg4 standard which is also in use for several years now and there has been no dramatic improvement here either.

Given that bandwidth demand of users is increasing exponentially, incremental gains in compression technology cannot provide a long term solution. In order to solve this problem there is a need for a bandwidth optimization system that scales with increasing user demand. This solution should also provide for reasonable user experience without compromising personalized content delivery.

Such a system is not known to exist in prior art that provides bandwidth optimization methods for both backhaul network and air interface, that scales with increasing user demand and provides reasonable user experience in regards to personalized content delivery.

Hence it can be seen that there is a need for a system that provides bandwidth optimization that scales with increasing user demand and offers a reasonable user experience while delivering personalized content.

Currently there are no known prior art methods that offer a solution to this problem.

Following paragraphs in current section describe relevant prior arts in this field.

Prior art U.S. Pat. No. 7,720,094 proposes a solution to compress data delivery in backhaul networks. This can only scale for information that is repeated and patterns of information bits that can be correlated. But this will not work for a series of images that have no correlation. Hence this solution cannot scale to provide improved bandwidth optimization as the user demand rises.

Prior art US Doc 20080207200 proposes a solution to increase cellular backhaul network bandwidth using high speed links such as millimeter wave links that provide high speed links. But this solution can be costly to implement and will not scale beyond the capacity offered by the spectrum available. Hence this solution may provide relief for immediate future but will not scale as bandwidth requirements increase exponentially.

Prior art US Doc 20100008290 proposes a caching mechanism at a cell site by using two channels of communication in backhaul network. Primary and ancillary channels are used to receive content from a content server and cache such content at a cell site. This method will suffer from the limitations stated above, as in a cell site there can be thousands of requests to retrieve data from billions of web pages in the internet. Hence the intersection between two independent requests is very minimal resulting in very few cache hits.

Prior art U.S. Pat. No. 7,801,530 proposes a method to dynamically compute future locations of mobile devices based on historical travel data and copy cached information from one cell site to neighborhood cell site based on several algorithms. This system may use multicasting between cell sites to save on bandwidth used for copying data between cell sites. But this system will also suffer from the same limitations about caching content at a cell site as described above. This system will have minimal cache hits across users as the intersection across user requests will be minimal. This system may only help in data retrievals of individual users when they move between cell sites, but that is a small scenario in comparison with the overall congestion problem across users who are browsing in a congested cell site.

Prior art US Doc 20050132049 proposes a method to provide several cache servers and prioritizes the cached content based on data providers and users. This method enables either caching main pages of premier content providers or caches user visited bookmarks. But this method will also suffer from the problem where a cache hit is limited to a very restricted set of users as the number of users per cell site or base station controller may be in thousands and the caching servers may not be able to store enough information for all of them. Also such caching algorithm only will work for past visited sites but not for future queries which a user may be interested in.

As can be seen from above, all known prior arts suffer from some limitations in offering a solution to the bandwidth problem in backhaul network and the air interface.

3. Objects and Advantages

Accordingly, several objects and advantages of the present invention are:
a) to provide a bandwidth optimization system that enables saving bandwidth in both backhaul and air interface;
b) to provide a bandwidth optimization system that provides a reasonable user experience in regards to delivering personalized content;
c) to provide a bandwidth optimization system that scales with user demand; and
d) to provide a bandwidth optimization system that uses social networking concepts to better utilize the available bandwidth.

### SUMMARY

In accordance with present invention a bandwidth optimization system is described that enables better use of backhaul network and air interface network in a cellular data network.

This is achieved by organizing data in the base station controller into an organized cache that can be viewed by mobile device users such that a mobile user is able to view contents of presently downloading data, data that is scheduled to be downloaded in future and data that is already downloaded into the cache across all users associated with a base station controller.

Organizing data and making it user viewable and providing incentives to users to download already existing data significantly reduces bandwidth usage in the backhaul network as data downloaded for one user can be reused by another user.

A user has a choice of setting up an independent data stream from interne, or download content from the organized cache. This enables maintaining user experience in regards to delivering personalized content.

In addition to saving bandwidth at the backhaul network, air interface bandwidth is also saved using organized content at the cache and allowing users to view and download future downloads in cache. If multiple users in the same cell site schedule data download of exactly the same files at approximately the same time interval, a network operator can selectively deliver this data using multicast technology thereby saving precious air interface bandwidth too. In order for this to work, a user interest in downloading content is made visible to all other users associated with a cell site thus increasing the likelihood that a user will choose a prescheduled download instead of getting an independent data stream.

Data organization in the data cache may also be improved using user input. Thus having the ability to view downloads from other users and influence organization of cache enables better cache hit rate.

This concept of viewing downloads across users and helping each other to reduce bandwidth usage is not known to exist in any prior art and is a new use of such social networking concept.

Thus it can be seen that organizing data in data cache such that it is user viewable, enabling mobile device users to view and choose already existing data based on incentives, enabling users to view and schedule downloads that are being viewed and scheduled by other users for future downloads, dramatically improves cache hit rate across all users associated with a base station controller, thereby reducing both backhaul and air interface bandwidth usage.

This concept of user viewable cache and providing incentives to users to download pre-existing content in the cache that might be related to their current download needs does not exist in any known prior art.

An example of such a system in operation is where multiple users download news articles on any particular day. In prior art systems each user may have different preferences in regards to news providers, some may get their news from new york times and some may prefer reuters. If these users are unable to see what other users are downloading, then each user will have to setup an independent download data stream.

But if all users are able to see what others are downloading then some users may choose to get their news from already downloaded content by other users. This reuse of existing content could potentially save a lot of bandwidth and associated cost in backhaul networks that enables an operator to give incentives to users who choose already existing content or content that can be downloaded once and used by many users in future.

The bandwidth optimization system of present invention does not preclude use of completely personalized streams such as email streams that are retrieved as usual. But streams that are open to public such as youtube videos, news articles, sports articles, stock market information, or other popular television programs available for download in internet can all be used with this system of present invention with high cache hit rate.

The bandwidth optimization system of present invention also offers benefits to network operators and mobile device users by providing a method that does not compromise on user experience and scales with user demand. As user demand for bandwidth increases, most users may go beyond their allocated total bandwidth for a month thus forcing users to consider using data that is already in the organized cache. This results in increased cache hit rates thus providing a cache system that scales with user demand.

The bandwidth optimization system of present invention is also better than other systems of prior art that offer compression algorithms to compress data, as compression algorithms are not good enough for exponentially increasing bandwidth usage.

The bandwidth optimization system of present invention is also better than predictive cache based systems since there is no way for a predictive cache algorithm to predict interest levels of two different users, hence providing very low cache hit rates.

The bandwidth optimization system of present invention is also better than conventional multicast network data dispatch since conventional multicast network is used for broadcasting preset programs such as television broadcasts and there is no way of knowing how many users will really tune into such programs as user interest is so diverse, hence wasting a lot of spectrum and associated bandwidth.

In the bandwidth optimization system of present invention, multicasting is selectively used only for those users who have agreed to download common content at common time intervals thus making very efficient use of multicast spectrum and associated bandwidth.

Thus it can be seen that the bandwidth optimization system of present invention can provide very high cache hit rates as compared with any system in prior art thereby saving precious bandwidth usage in both backhaul networks and air interface networks.

### DRAWINGS

### Figures

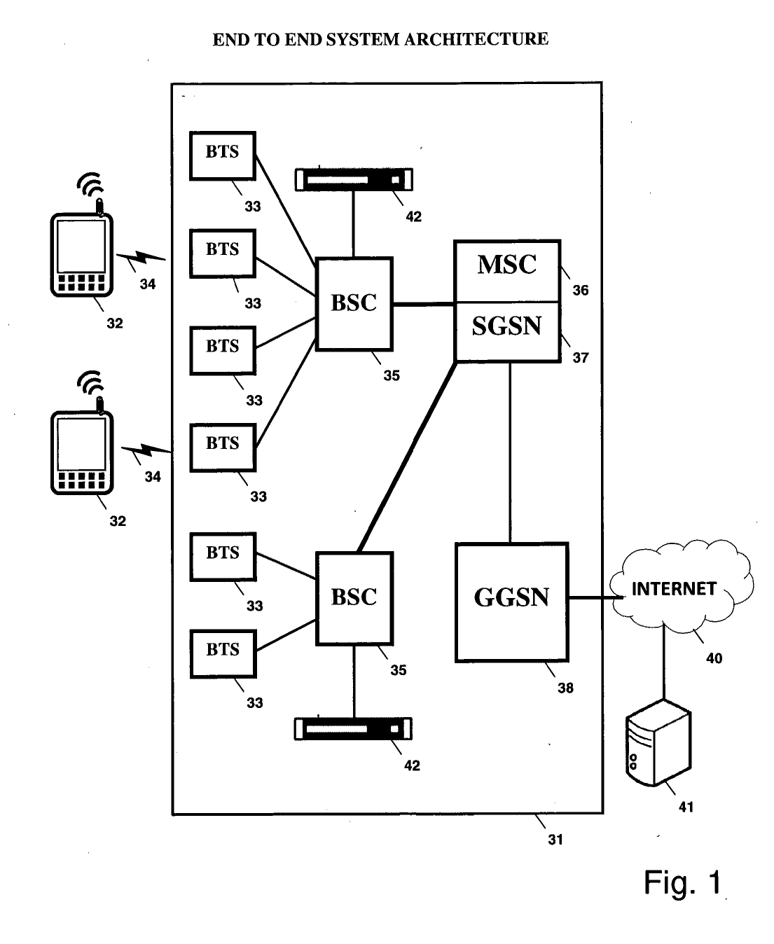

FIG. 1 shows end to end system with mobile device having the ability to view cache contents from cache data in base station controller.

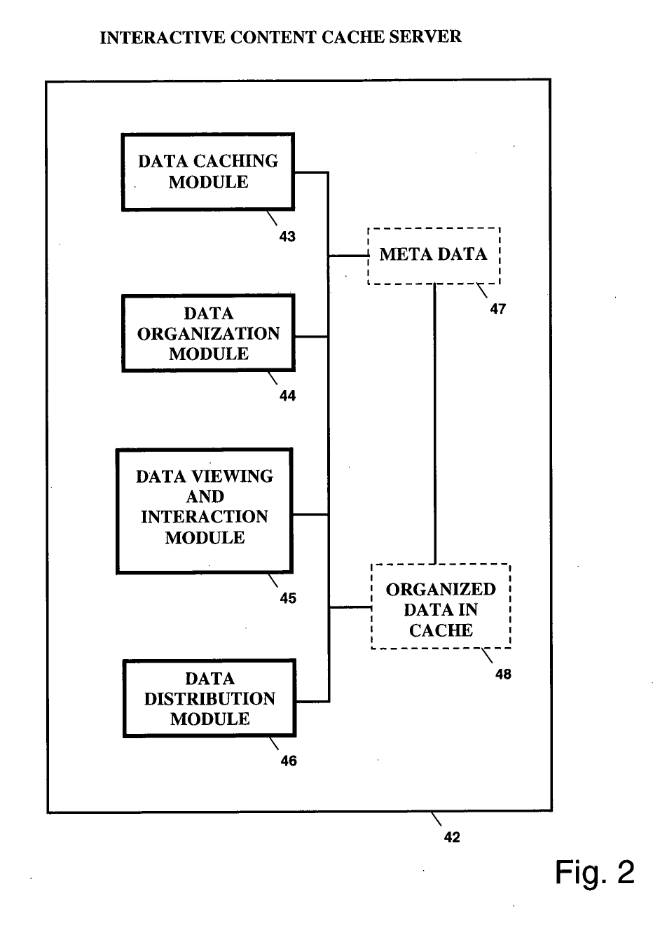

FIG. 2 shows details of interactive content cache server that stores and manages data from user requests.

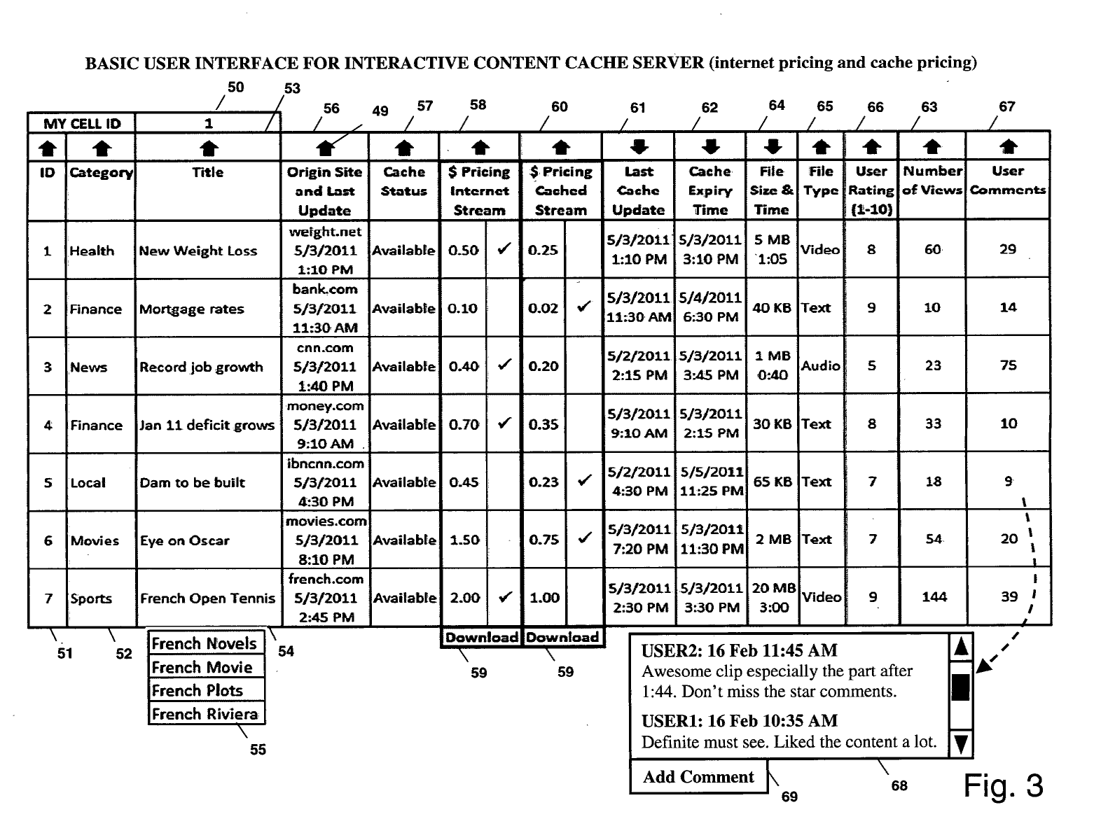

FIG. 3 shows basic user interface for interactive content cache server showing ability to fetch data directly from the internet or cached data from the interactive content cache server.

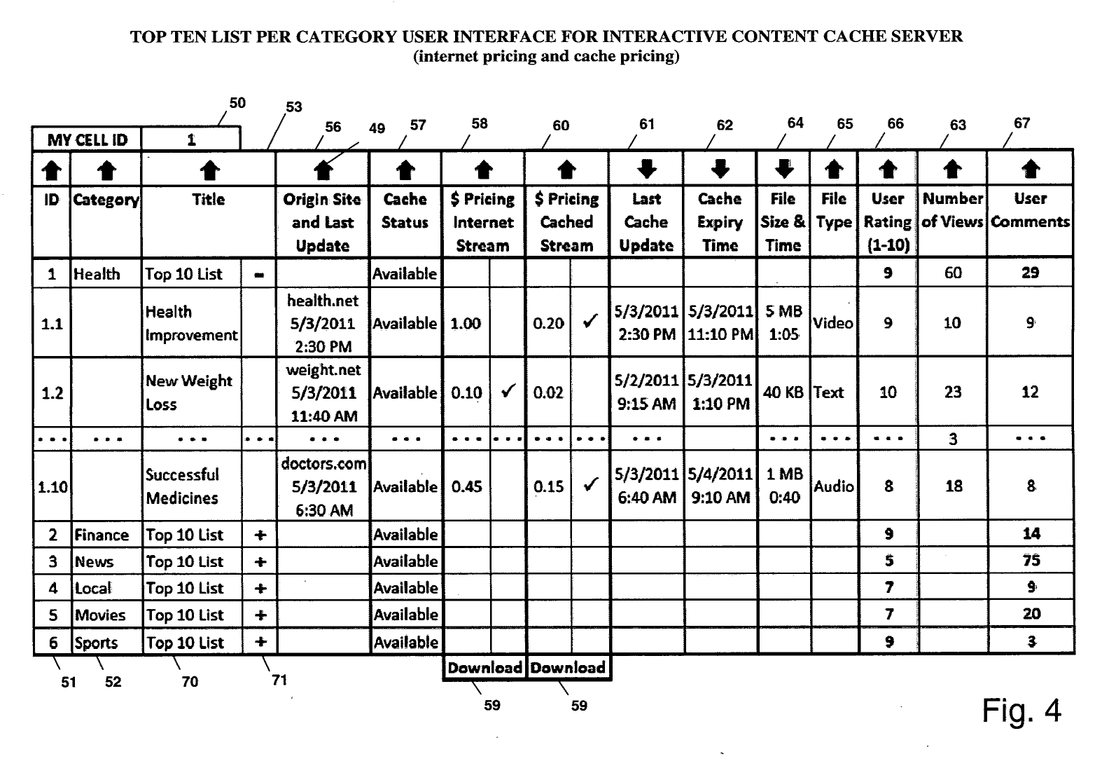

FIG. 4 shows top ten list user interface for interactive content cache server showing list of top ten downloads and the ability to fetch data directly from the internet or cached data from the interactive content cache server.

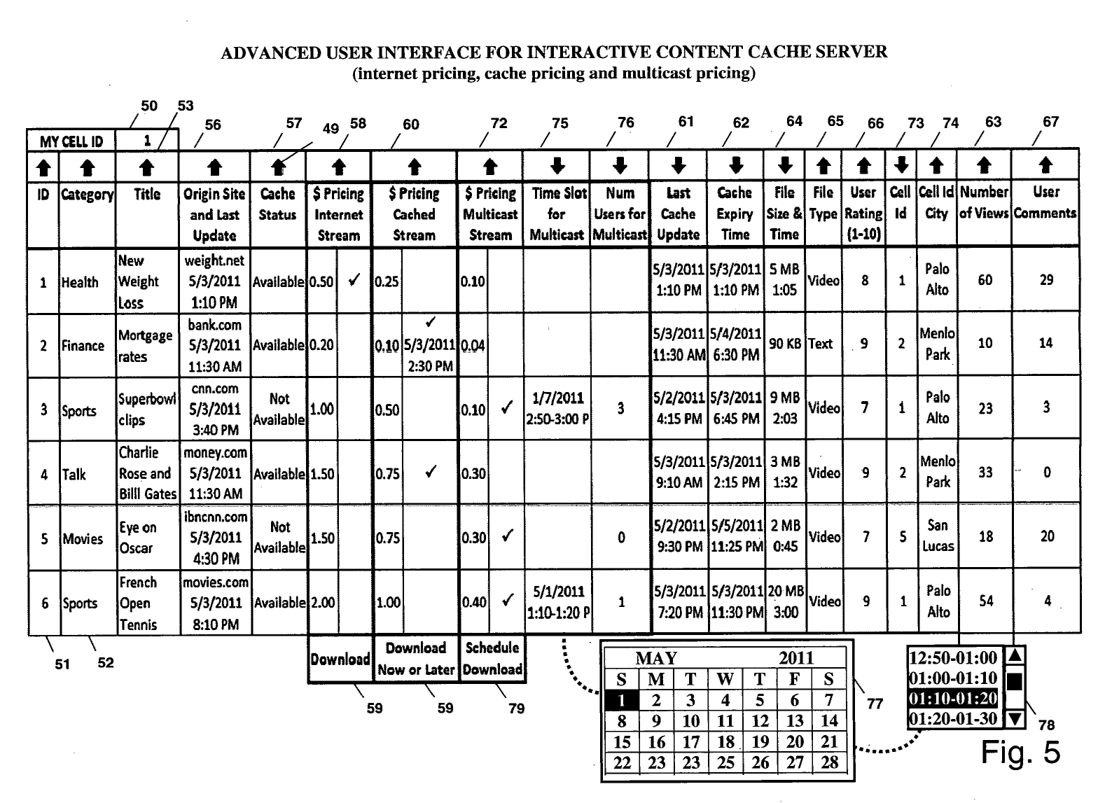

FIG. 5 shows advanced user interface for interactive content cache server showing ability to fetch data directly from the internet or cached data from the interactive content cache server or cached data fetched using multicast methods.

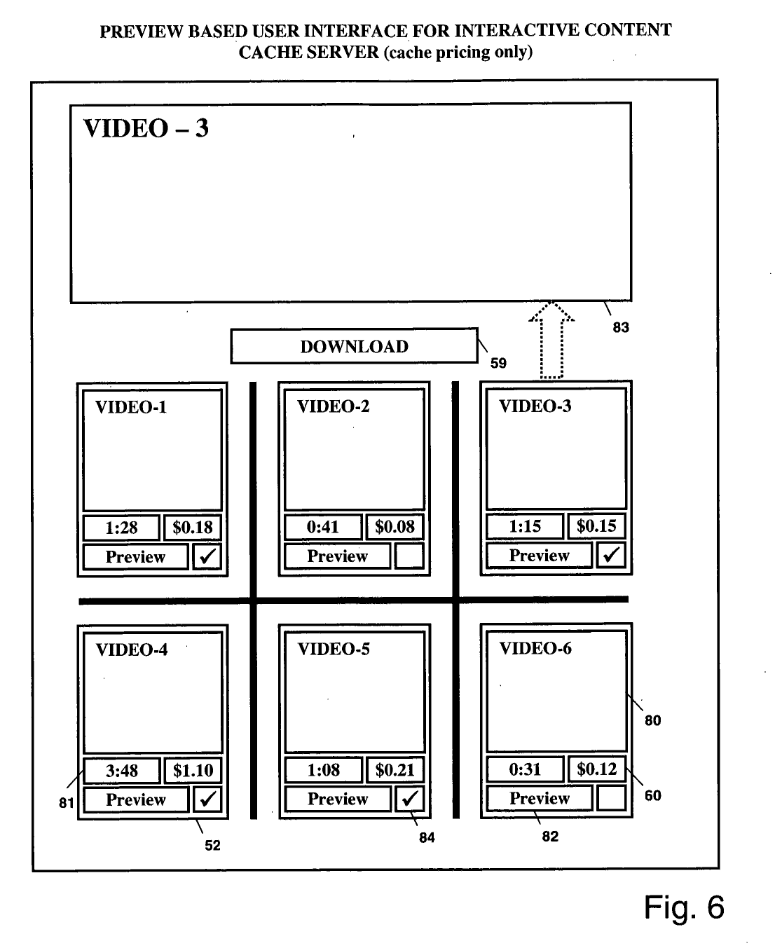

FIG. 6 shows preview based user interface for interactive content cache server showing ability to fetch data directly from the internet or cached data from the interactive content cache server.

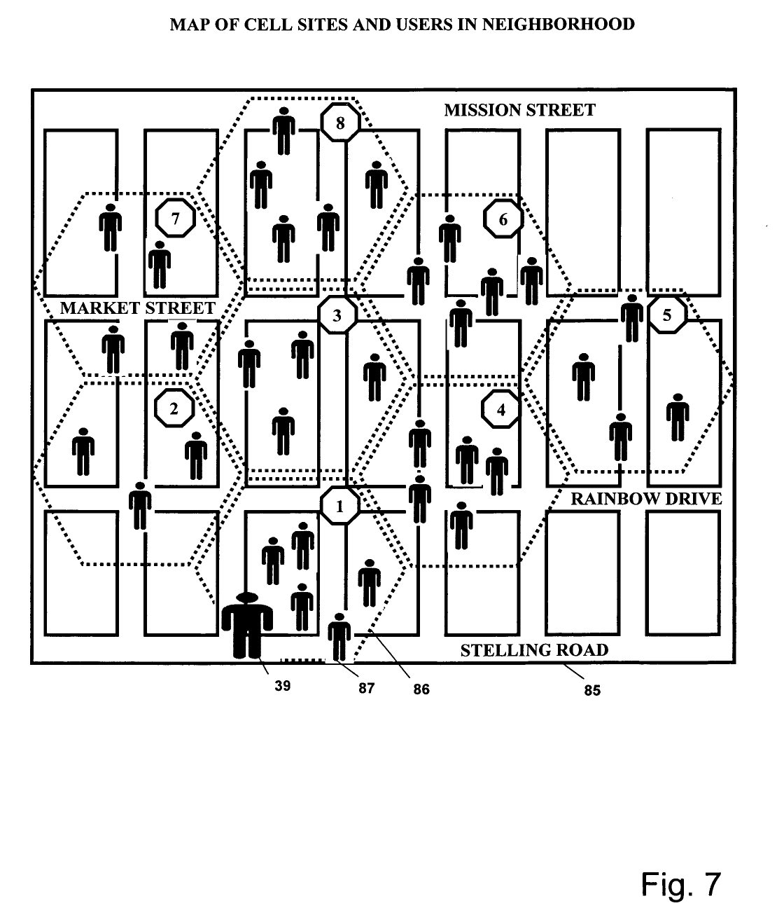

FIG. 7 shows a map of cell sites in vicinity of a user along with users in other cell sites.

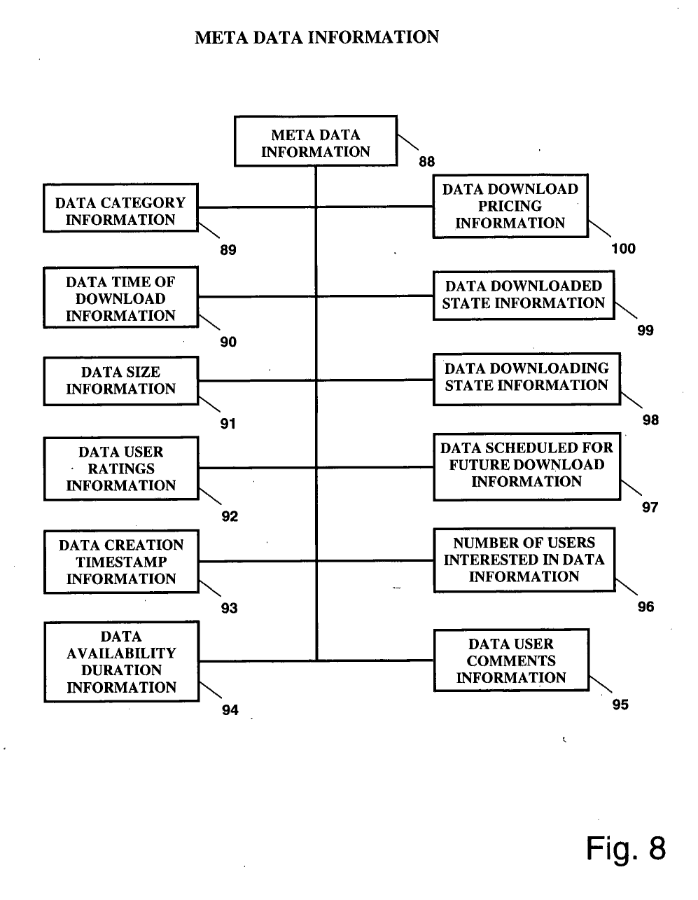

FIG. 8 shows the various components of meta data stored in the interactive content cache server.

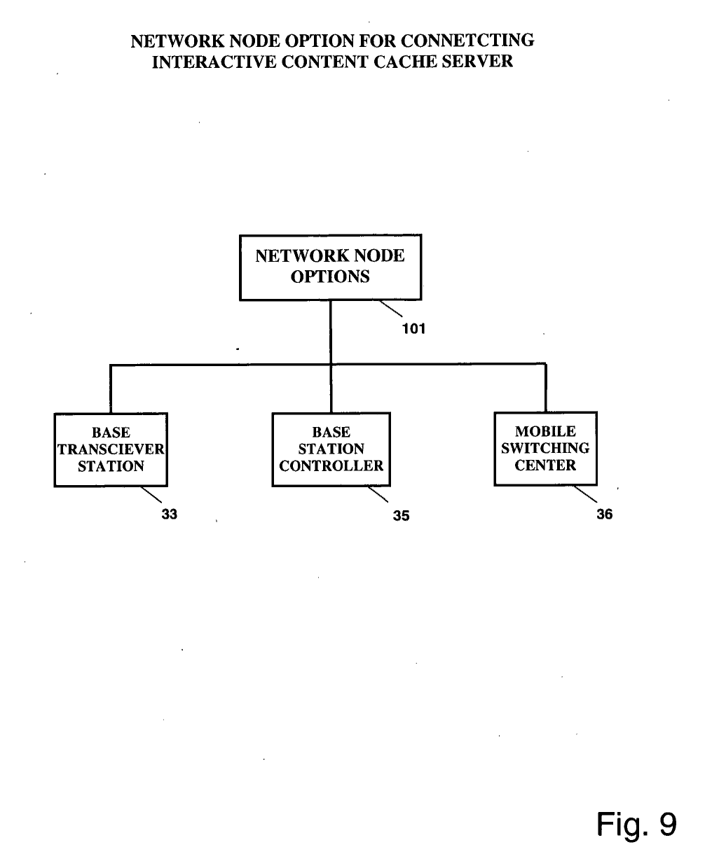

FIG. 9 shows different network node options for connecting to interactive content cache server.

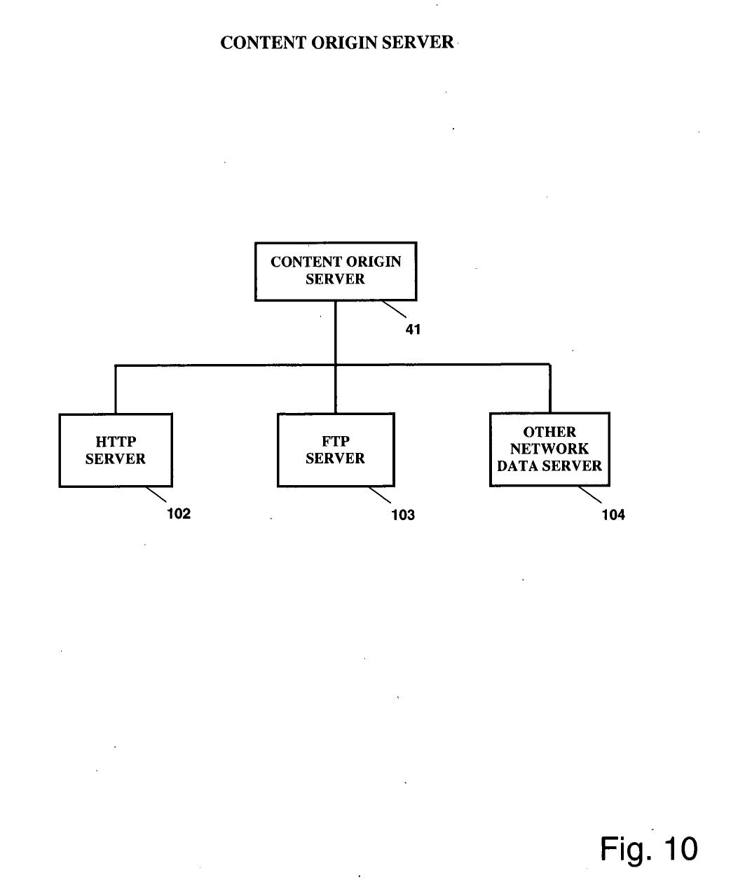

FIG. 10 shows different types of content origin servers that can be connected to the internet.

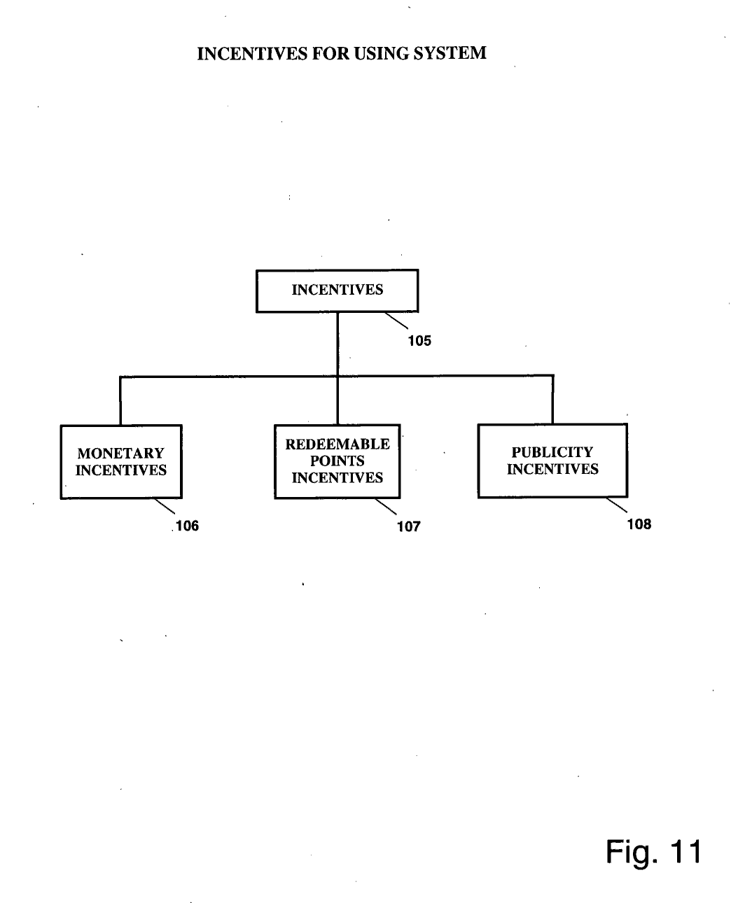

FIG. 11 shows various incentives that can be provided to a user for downloading data from interactive content cache server.

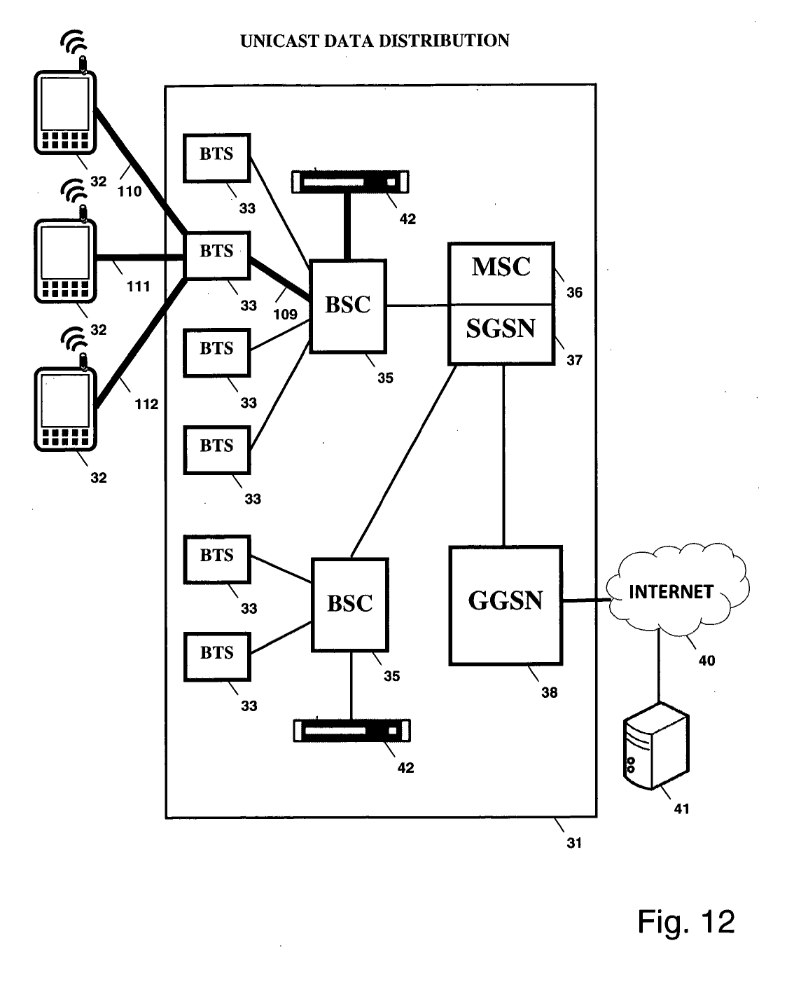

FIG. 12 shows unicast data distribution method.

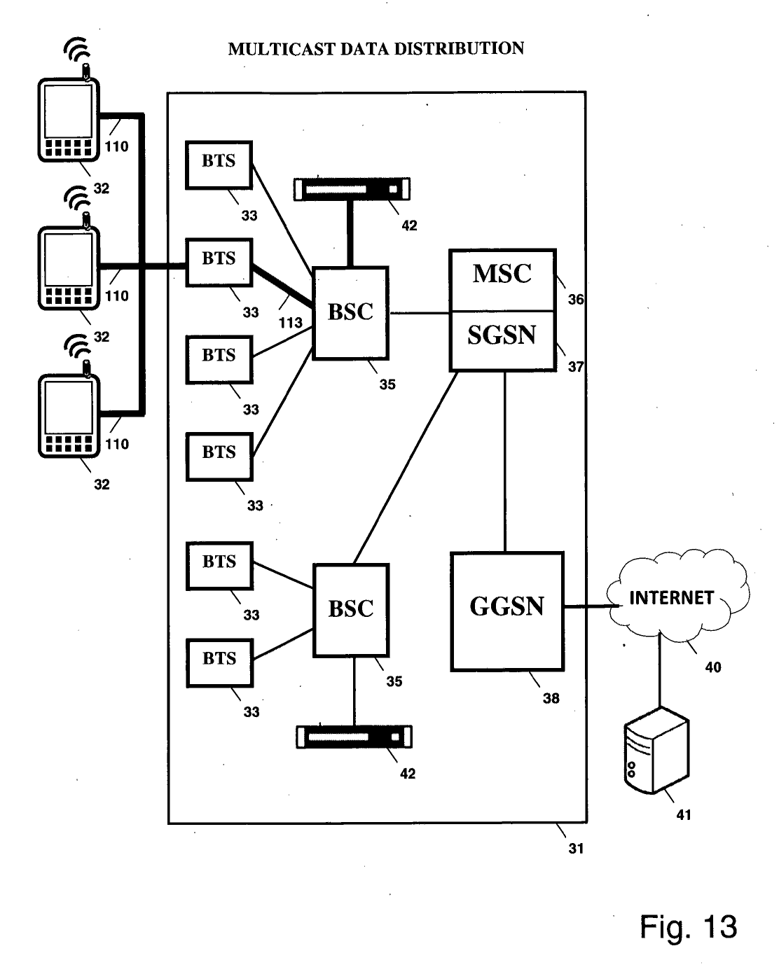

FIG. 13 shows multicast data distribution method.

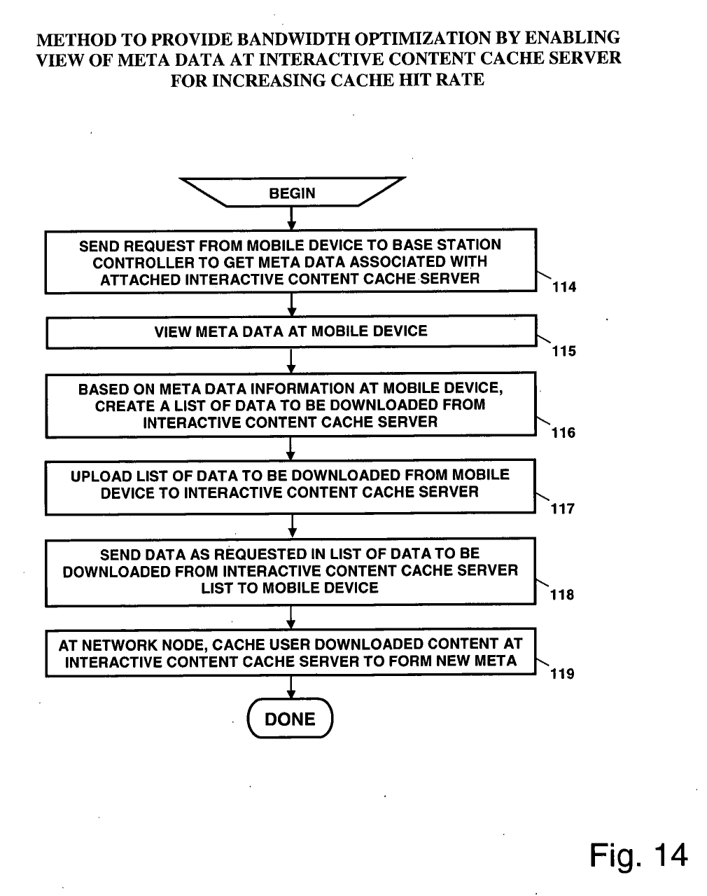

FIG. 14 is a flow chart of a method that provides bandwidth optimization by enabling view of meta data at interactive content cache server.

### REFERENCE NUMERALS

31 wireless data communication network
32 mobile devices
33 base transceiver stations (BTS)
34 air interface
35 base station controller (BSC)
36 mobile switching center (MSC)
37 general packet radio service support node (SGSN)
38 gateway general packet radio service support node (GGSN)
39 user
40 internet
41 content origin server
42 interactive content cache server
43 data caching module
44 data organization module
45 data viewing and interaction module
46 data distribution module
47 meta data
48 organized data in cache
49 sort arrow
50 current cell site identifier
51 content article identifier
52 information category
53 content title
54 search box
55 drop down box
56 origin site and last update information
57 cache status
58 pricing for internet stream
59 download button
60 pricing for cached stream
61 last cache update information
62 cache expiry time
63 content cache views
64 file size and playback time
65 file type
66 user ratings
67 count of user comments
68 user comments dialog box
69 add comment button
70 top ten lists
71 expansion icon
72 pricing for multicast stream
73 content article cell identifier
74 city name
75 time slot for multicast download
76 number of users for multicast
77 drop down calendar
78 time slot dropdown list
79 schedule download button
80 video clips
81 time duration
82 preview button
83 video display window
84 selection check box
85 map
86 cell sites
87 other users
88 meta data information
89 data category information
90 data time of download information
91 data size information
92 data user ratings information
93 data creation timestamp information
94 data availability duration information
95 data user comments information
96 number of users interested in data information
97 data scheduled for future download information
98 data downloading state information
99 data downloaded state information
100 data download pricing information
101 network node options
102 web servers
103 file transfer protocol servers
104 other network data servers
105 incentives
106 monetary incentives
107 redeemable point incentives
108 publicity incentive
109 unicast data distribution system
110 channel one
111 channel two
112 channel three
113 multicast data distribution system
114 step
115 step
116 step
117 step
118 step
119 step

### DETAILED DESCRIPTION OF PREFERRED EMBODIMENT

In the following description, first an end to end system for bandwidth optimization is described followed by details of the interactive content cache server. Usage of this system is illustrated with specific examples. The method that provides bandwidth optimization by enabling view of meta data at interactive content cache server is also described.

FIG. 1 shows end to end wireless data communication network 31 consisting of different mobile devices 32 having the ability to view cached data. Wireless data communication network 31 includes mobile devices 32 that are connected to base transceiver stations (BTS) 33 via air interface 34. The Mobile device 32 can be one of cellular phone, smart phone, laptop computer, network appliance, navigation device, personal digital assistant, wireless modem, tablet device and other similar devices.

Base transceiver station 33 consists of one or more radio antenna elements and handles radio link protocols with mobile devices 32. Base transceiver station 33 may be distributed geographically into cell sites that are defined by radio frequency radiating pattern from its antennas. Based on radiation pattern of antennas, the cells sites can be further divided into sectors that define coverage area of base transceiver station 33. Throughout a coverage area, base transceiver station 33 may be spread out in a manner so as to provide best coverage for mobile devices 32 in its proximity. When mobile device 32 moves across cell sites, base transceiver station 33 that mobile device 32 is connected to, shifts control to neighboring cell sites based on acceptable signal levels, resulting in a smooth transition called a handoff. The transmitting power of base transceiver station 33 defines the size of a cell site. In large urban areas, several base transceiver stations 33 may be deployed to cater to a large population density.

Function of base transceiver station 33 can include, but not limited to, encoding, encrypting, multiplexing, modulating and feeding radio frequency signals to its antenna, transcoding and rate adaption, decoding, decrypting and equalizing received signals and voice through full or half rate services.

Several base transceiver stations 33 can be coupled to base station controller (BSC) 35. Base station controller 35 manages radio resources including radio channel setup, control of frequency hopping and inter cell handovers for one or more base transceiver stations 33. Some of the other radio resource and network management functions for base station controller 35 include but are not restricted to, reallocation of frequencies among base transceiver stations 33, power management, time and frequency synchronization, providing an interface to operations and management centers, and performing traffic concentration to reduce the number of lines from mobile switching center (MSC) 36. Base station controller 35 is essentially an interface between base transceiver station 33 and mobile switching center 36.

Cellular networks contain several mobile switching centers 36 each of which handles communication with a cluster of base station controllers 35 and cell sites. Mobile switching center 36 takes care of resource management of network interfaces towards base station controllers 35 and is responsible for call processing and handovers between two or more mobile switching centers 36. The serving general packet radio service support node (SGSN) 37 is a packet version of mobile switching center 36 and requires the services of a packet switch to perform its role in packet data networks. Some of the functions of the SGSN include mobility management, routing of packet data using the internet protocol, session management, authentication, encryption, managing usage and charging information and compression and temporary storage capability.

Mobile switching center 36 is connected securely to external packet data networks through gateway general packet radio service support node (GGSN) 38. All packet data traffic from public data network is routed through GGSN.

Except for air interface 34, each of the couplings within the wireless data communication network 31 may be interfaces such as trunk level 1 (T1) lines, optical carrier 1 (OC-1), ethernet lines, signaling links or similar communication links.

A typical user 39 request for internet data from mobile device 32 involves passing request data from mobile device 32 to base station controller 35 via the base transceiver station 33.

From base station controller 35, the request is routed to SGSN 37 from where it is sent to internet 40 through GGSN 38. Internet 40 routes the request to appropriate content origin server 41 to process the request. Content origin server 41 then sends back the requested information through the same route in reverse, back to mobile device 32. In doing so, an independent data stream is opened between mobile device 32 and content origin server 41 that continues to process requests. This data stream is closed when the user terminates the request or when all data corresponding to the request is already dispatched.

The coupling between base station controller 35 and mobile switching center 36 is referred to as the backhaul network and consists of leased T1 lines that are expensive to deploy and maintain. The backhaul network is one of the primary data bottlenecks in cellular data network 31. The ever increasing demand for bandwidth to support next generation mobile devices 32 need backhaul networks that are flexible, have higher bandwidth capacity and cheaper cost per megabit transmitted than legacy networks. Since replacing backhaul networks with newer technology like packet based backhaul over optical fiber using ethernet is a time consuming and expensive process for mobile operators, there is a tendency to continue using legacy connections. The coupling between the SGSN 37 and GGSN 38 and internet 40 is usually enabled using standard high speed ethernet cables. With the explosion of mobile device 32 users on cellular data networks 31, the backhaul network is experiencing a dramatic increase in data traffic leading to significantly higher congestion rates that is progressively getting worse over time.

The present invention describes a bandwidth optimization solution that aims to reduce congestion at both the air interface and the backhaul network in cellular data networks 31 using social networking concepts implemented in interactive content cache server 42 coupled to base station controller 35. Interactive content cache server 42 is used to store and manage data in a cache and enables viewing and editing of cache data by users of mobile devices 32 communicating with base station controller 35 and corresponding interactive content cache server 42. Users have the option to view and select data in the cache for immediate download or future downloads. This enables reuse of existing data in content cache instead of fetching an independent data stream from internet 40.

Coupling interactive content cache server 42 to base station controller 35 ensures high cache hit rates that enables users to select and view content fetched by other users of similar internet content requirements. This translates into significant cost savings to both users and cellular network operators. With reduced data delivery costs, cellular network operators can accommodate more users per cell site and at the same time charge less to each user for data access. For cellular network operators, this translates directly into overall costs savings and reduction of churn rates of its subscribers.

FIG. 2 is a block diagram illustrating the components of interactive content cache server 42 that stores and manages data from users 39. Interactive content cache server 42 consists of three main components namely data caching module 43, data organization module 44, data viewing and interaction module 45, and data distribution module 46.

Data caching module 43 enables caching content that is downloaded from content origin server 41 for requests generated by mobile device 32 users. The cached content can be influenced by several factors including time of data generated, duration for which users 39 desire the data be kept in the cache, user demand on certain data categories, and popularity of categories.

Data caching module 43 also has policies to clear up old and unused data based on algorithms such as least recent used data algorithm that cleans up data that is not requested within a specified time period.

Data caching module 43 also extracts meta data 47 from organized data in cache 48 so that users are able to view real content in context of meta data 47 that enables better utilization of existing data in data caching module 43.

Data caching module 43 interacts with data organization module 44 and passes it meta data 47 information that is extracted. The meta data 47 information may also be received from content origin servers 41 or intermediate hyper text protocol (HTTP) proxy servers. This enables data caching module 43 to present an expanded set of meta data 47 information about original content thus improving the filtering capabilities for a user.

Data caching module 43 may be implemented as hardware or software or as a combination of the two and may use standardized web protocols to interact with data servers coupled to servers in base station controller 35. If base station controller 35 uses standardized HTTP proxy servers then data caching module 43 may be implemented as a plugin to a proxy server.

Data caching module 43 may also use compression techniques to compress original content to further reduce bandwidth utilization between base station controller 35 and mobile device 32 for content that is not already compressed. This also conserves space in data caching module as caching original content data and corresponding meta data 47 for several thousand users can become expensive.

Data organization module 44 receives original content data and corresponding meta data 47 from data caching module 43 and uses the received meta data 47 to organize original content data into multiple categories. These categories can be further sub divided into folders and then original content is placed into appropriate folders.

Data organization module 44 enables users to correlate several independent data streams based on meta data 47 that is collected and categorized, so that common elements across original contents may be easily filtered and grouped together to get a uniform view of the entire data set instead of the ability to view only partial information.

Data organization module 44 also enables users to edit existing organization by enabling users to add new entries, delete existing entries or move existing entries to new folders or categories.

Data organization module 44 also provides access restrictions so that only privileged users may alter existing data organization so that cached data maintains validity at all times.

Data organization module 44 also keeps track of costing of each of the original content data streams and provides users multiple options in terms of pricing based on various download schemes. This costing structure may be influenced by network operators and number of users interested in specific data streams. Hence data organization module 44 may also be coupled to network operator billing systems. Costing of original content determined by data organization module 44 may uses statistics from base station controller 35 such as number of users in a particular cell site and number, time of download, and number of users interested in particular download.

Data organization module 44 also may generate top ten lists based on often fetched data from users. This enables generating a list of top ten downloads in each of the categories so that users may use this list as a starting point for scheduling downloads. Hence it can be seen that data organization module 44 enables users to see data that is being downloaded or scheduled for download by other users and also provides a list of downloads that may be of interest to a wide audience as top ten lists.

Data organization module 44 also enables scheduling of downloads that users are interested in. This scheduling can be based on unicast network data dispatch scheme or multicast network data dispatch scheme. In the unicast scheme, data is downloaded from base station controller 35 into mobile device 32 using independent data stream, whereas in multicast scheme, data is downloaded from base station controller 35 into mobile device 32 using one stream that is applicable to many mobile device 32 users in the same cell site. Multicast dispatch scheme will most likely be used for video data that can be very bandwidth intensive if dispatched using unicast scheme. This selective implementation of multicast scheme with information about common user interest is not known to exist in prior art.

Data viewing and interaction module 45 receives data from data organization module 44 and provides multiple views of original content cached in data caching module 43 along with corresponding meta data 47 to provide interaction functionalities such as viewing and editing.

Viewing functionality may include sorting, filtering, incremental filtering, search based filtering, pagination, fast scrolling, and column filtering. Editing functionality may include inserting and deleting columns and rows, changing attributes of existing entries, linking several entries together using formulae, updating existing entries, creating child entries of existing entries and creating new folders.

Data viewing and interaction module 45 may produce views that resemble standard hypertext markup language (HTML) pages or advanced user interfaces such as spreadsheets that provide a high degree of interactivity. Such views may use standard programming paradigms such as javascript, html and asynchronous javascript based on XML (AJAX) and HTTP. Future web communication protocols such as web sockets may also be used in order to exchange large amounts of meta data 47 and with mobile device 32 user agents such as HTML browsers in a timely and efficient manner.

Data viewing and interaction module 45 may use binary protocol to exchange data between base station controller 35 and mobile device 32 in order to save on bandwidth and speed up data delivery to mobile device 32 and reduce parsing overheads. This will enable users to interactively view and edit meta data 47 at interactive content cache server 42. This binary protocol may be used with or without base 64 encoding depending on browser support for web socket protocol. Using binary protocol will enable updates to existing views of meta data 47 in very efficient manner and hence increase the effectiveness of meta data 47 being viewed by a user. For example, a user 39 need not query to find out how many other users 39 are interested in a particular content stream, but instead may be notified by constantly updating cell content in meta data 47 view in mobile device 32. Based on the rate of updates, a user 39 may infer the interest level in particular original content stream thereby enabling user 39 to make an appropriate choice of whether to download the stream now or wait for a later point in time where multiple users 39 may want the same data stream for a lesser price.

Data viewing and interaction module 45 may also provide a user a view of all downloads a user has participated in and show statistics and graphs showing how the users budget was spent. This can be used to compare user monthly bills with other options such as prepaid data bundles or postpaid data.

Data viewing and interaction module 45 may also enable users to communicate with each other in context of content to be downloaded from interactive content cache server 42 so that users may co-ordinate their presence at certain cell sites ahead of time. This system will maximize the number of users that can be present for multicast dispatch scheme. This communication may be of different types including text based instant messaging, or in context messaging in the currently visible view of meta data 47 or other communication means.

Data viewing and interaction module 45 may also enable several user requests at nearby time slots to be combined into a single time slot that may be acceptable to most users in a specific request list. This will again enable efficient reuse of multicast time slots.

Data distribution module 46 enables data distribution of organized data and meta data 47 using unicast data distribution methods, and multicast data distribution methods.

FIG. 3 shows basic user interface for interactive content cache server showing ability to fetch data directly from internet 40 or cached data from the interactive content cache server 42. This figure shows a tabular representation of the cached data organized with each row corresponding to a recently visited website, further referred to as cache table. Each column of the table can be sorted in ascending or descending order by clicking on sort arrow 49.

The first row of the table contains current cell site identifier 50 that is used to indicate the cell site in which a user is currently located in. Current cell site identifier 50 helps a user map their cell site numbers to neighborhood cell site numbers so that the user can know what content is cached at desired cell site.

The first column of the table is content article identifier 51 that is a unique number assigned to a content article in the cache table.

The next column in the table is information category 52 for all content in content cache of interactive content cache server 42. Examples of some of information categories 52 include automobiles, finance, games, health, international, jobs, news, movies, real estate, shopping, sports, talk show, travel, weather, and other similar content articles.

The next column is content title 53 that contains the title of the content article of interest in content cache of interactive content cache server 42 associated with a particular category 52.

User 39 also has the option to search for content by directly entering the search string in search box 54 in an appropriate cell of content title 53 column. Upon entering the first few characters of content related title to be searched, drop down box 55, with similar titles is displayed. These titles correspond to data that currently exists in content cache of interactive content cache server 42. On selecting desired content title 53, the new title information is transferred to the title area cell, following which subsequent cells in the table are updated with corresponding meta data 47 information. The user also has the option of ignoring the drop down box 55 and directly entering all of the title information to be searched from content cache of interactive content cache server 42.

The third column shows origin site and last update information 56 of the content. This has a web page link showing address of content origin server 41 associated with content title 53 and time of last update at content origin server 41. Since many web page links tend to contain large number of characters, web page links could be truncated to fit into the displayed space. Last update is the date and time stamp at which the content of origin site was last modified. User 39 can compare date and time stamp of content at origin site with date and time stamp of content in cache of interactive content cache server 42 to determine if content in cache is sufficient for download or if updated content from content origin server 41 needs to be downloaded from the internet.

The next column contains cache status 57 to indicate the status of the cached information in content cache of interactive content cache server 42. The possible cache status 57 values are available and not available. Available status indicates immediate availability of content in content cache of interactive content cache server 42 and not available status indicates that the content is not available in content cache of interactive content cache server 42. In this example, status of all content articles is marked available for download. The next column shows pricing for internet stream 58 that indicates cost to a user 39 for downloading information directly from internet 40 as an independent data stream. User 39 can select one or more content articles to be downloaded directly from internet 40 by clicking checkboxes adjacent to text showing pricing for internet stream 58 in corresponding cells of the table. Once all desired content articles are selected, user 39 can initiate a download by clicking on download button 59 at the bottom of this column. Even if the content is available in content cache of interactive content cache server 42, some users 39 may want the latest information and hence may choose to download directly from the internet 40 thus incurring internet stream 58 pricing. User 39 may make this determination based on last update status of content at origin site as shown in origin site and last update information 56 column.

The next column shows pricing for cached stream 60 that indicates cost to a user for downloading information content cache of interactive content cache server 42. User 39 can select one or more content articles to be downloaded from content cache of interactive content cache server 42 by clicking checkboxes adjacent to text showing pricing for cached stream 60 in corresponding cells of the table. Once all desired content articles are selected, user 39 can initiate a download of all content from content cache of interactive content cache server 42 by clicking on download button 59 at the bottom of this column.

The next column shows last cache update information 61 which is a time stamp of date and time content cache of interactive content cache server 42 was last updated for a particular content article.

The next column shows cache expiry time 62. This is the date and time at which downloaded content will be deleted from content cache of interactive content cache server 42. The system can increase cache expiry time 62 if the number of users interested in downloading this cached content increases which is gauged by number of content cache views 63 of a particular content article. The expiry time extension is inversely proportional to the time it takes to reach a certain number of downloads. This is because an increase in download activity indicates an interest in the content and the likelihood of more users downloading it in the immediate future. An example of such information could be a video clip that becomes popular and goes viral on the internet resulting in millions of user viewings.

The next column shows file size and playback time 64 of content article from content cache of interactive content cache server 42. File size 64 is shown in megabytes and kilobytes and playback time is indicator of length of time take to play a video or audio file.

The next column shows file type 65 of content article from content cache of interactive content cache server 42. Examples of file types 65 are video, text, audio and a mix of similar file types. After viewing downloaded content, users can update content cache of interactive content cache server 42 with user ratings 66 on a scale of one to ten with ten being the highest rating and one being the lowest rating.

The next column shows number of content cache views 63. This is a count of the number of times content has been downloaded from content cache of interactive content cache server 42.

The next column shows count of user comments 67 for a particular article. By clicking on the cell corresponding to this column, user comments dialog box 68 opens up to display the list of comments entered by users 39 pertaining to the article. The comments are displayed in order of latest comments showing up first followed by older comments. All comments are preceded by the user name, date and time of creation of the comment. The user can scroll down the list to view all the comments. After interacting with content from an article, user 39 has the option of adding new comments by clicking on add comment button 69. If user 39 adds a new comment, then count of user comments 67 is incremented by one in the corresponding cell of user comments 67 column.

FIG. 4 shows top ten list user interface for interactive content cache server 42 showing list of top ten downloads and the ability to fetch data directly from the internet or cached data from interactive content cache server 42. The columns in this interface are identical to the basic user interface except for the addition of top ten lists 70 for each of the content article categories 52. Each entry in the top ten lists 70 can be expanded to reveal details about the content title 53 by clicking plus sign of expansion icon 71. User 39 can then interact with the menu using the same columns as in basic interface. The top ten lists 70 are updated periodically with the latest information of the content articles and are generated automatically without any user intervention or request.

FIG. 5 shows advanced user interface for interactive content cache server 42 showing ability to fetch data directly from the interne or from content cache at interactive content cache server 42 using unicast methods or multicast methods. In addition to all the columns of basic user interface, three new columns are added in this user interface. The new columns added are pricing for multicast stream 72, content article cell identifier 73, and city name 74.

Pricing of multicast stream 72 is the cost of cached content that is delivered through multicast methods. Pricing of multicast stream 72 can be much lesser than pricing of internet stream 58 and pricing of cached stream 60. This can be configured by cellular network operators. Pricing of multicast stream 72 can be lower because users share the same communication channel from base station controller 35 to air interface in cell sites corresponding to user location. The multicast stream shares one single stream at a predefined date and time. The date and time is specified by user 39 in time slot for multicast download 75 column. User 39 can select a date and time for multicast downloading of content in near future.

There are two scenarios for selecting the date and time for multicast downloads for a specific content article. Selection of date and time for future download is also referred to as adding to a user wish list. A user can either create a new entry for a wish list or can join other users wish list. A wish list is tracked using number of users for multicast 76 column. In the first scenario, if there are no users listed in number of users for multicast 76 column, then drop down calendar 77 appears when the user clicks on the time slot cell for multicast download 75 column. Once a date is selected, the user can also select the multicast download time slot from time slot dropdown list 78 that contains a list of available time slots for multicast download. After user 39 selects a time from time slot drop down list 78, both date and time slot for multicast download is registered in time slot for multicast download 75 column. A check mark then appears automatically in the box adjacent to pricing of multicast stream 72 along with the actual pricing for the multicast download. User 39 has an option to deselect the choice in which case the date and time of download entry is removed from the time slot of multicast download 75 column. After selecting the desired time slot for multicast download 75, the user can click on schedule download button 79 to schedule the multicast download.

In the second scenario, if the number of users for multicast 76 column count is filled, then no time slot dropdown list 78 will appear indicating that the user can only download the content article in the predefined times slot. When the number of users for multicast 76 column count reaches a preconfigured threshold number, the desired content is brought into the content cache of interactive content cache server 42.

The next column shows content article cell identifier 73 that indicates the cell site number for each content article that is associated with corresponding base station controller 35 and interactive content cache server 42. By looking at a layout map of the cell identifiers 73 in the vicinity of cell site associated with user 39, the user can determine whether it is cost effective to download content from the current cell site or wait for download until reaching the desired new cell site.

The next column shows city name 74 corresponding to cell site number 73. By displaying the city name, a user can easily identify the location where the desired content is cached and available.

FIG. 6 shows preview based user interface for interactive content cache server 42 showing list of top ten downloads and the ability to fetch data directly from the internet or cached data from interactive content cache server 42. This figure shows collection of cached data organized as picture icons representing video, music or data. In this example, the collection consists of video clips 80 arranged in a tabular grid. With each video clip 80 is associated time duration 81 and pricing for downloading cached stream 60. Preview button 82 when clicked plays a five second clip of video in video display window 83. User 39 then has the option of selecting, video clip 80 to be downloaded from interactive content cache server 42 by clicking on selection check box 84. All selected video clips 80 can then be downloaded by clicking on download button 59.

FIG. 7 shows map 85 of cell sites 86 in the vicinity of user 39 and shows the location of other users 87 within each of the cell sites 86. The cell borders are shown as hexagon outlines. Each cell site 86 is marked by a cell identifier 50. In this illustration, the map 85 contains a total of eight cell sites. User 39 is located in cell site one along with four other users 87 in the same cell site 86. The location of each of the other users 87 is indicated by an oval icon on the map 85. By clicking on any cell site 86, user 39 can see a list of cached content in that cell site 86. Then depending on the pricing and duration of availability of content in cache, user 39 can select and download content. If user 39 decides to travel to another cell site 86 in the near future, then by looking up cached content list at that cell site 86, user 39 can set a future time of download to coincide with time at which user 39 will be available at that cell site 86.

FIG. 8 shows different types of meta data information 88 stored in interactive content cache server 42. The Data category information 89 refers to the categorization of the meta data 47 based on high level categories that are updated from time to time. These categories reflect popular categories already available on the internet at heavily visited sites like yahoo and google. Data time of download information 90 pertains to date and time of data downloaded into content cache at interactive content cache server 42, while data size information 91 refers to the size in mega bytes or kilo bytes of data stored in the cache. Data user ratings information 92 is a rating of popularity of the information on a scale of one to ten. Data creation timestamp information 93 corresponds to the date and time at which the data was first created at content origin server 41. This data creation timestamp information 93 is used to determine the duration that data will reside in the cache which is stored as data availability duration information 94 in interactive content cache server 42. Data user comments information 95 is a collection of user comments along with the date and time the comments were written for a particular content article. Number of users interested in data information 96 is an indication of how many users are interested in content articles as shown in the table rows. Data scheduled for future download information 97 refers future time of download that user 39 may be interested in. Data downloading state information 98 and data downloaded state information 99 correspond to the two states of downloaded and downloading data from content cache at interactive content cache server 42. All information pertaining to pricing of data is stored as data download pricing information 100 that is determined by several factors including the number of users 39 requesting a particular content article, whether the download distribution method is unicast or multicast, and the size and duration of content articles in content cache of interactive content cache server 42.

FIG. 9 shows the different network node options 101 for integrating interactive content cache server 42. Interactive content cache server 42 can be integrated with base transceiver station 33 or base station controllers 35 or mobile switching center 36. The preferred option is to integrate interactive content cache server 42 with base station controller 35. Integrating with base transceiver station 33 may further reduce bandwidth needs of base station controller 35 but doing so will reduce user choice of the content set available for viewing. Integrating with mobile switching centers 36 may provide wider content choice but will reduce backhaul bandwidth efficiency.

FIG. 10 shows the different-types of content origin servers 41 that can provide content via the interne. These are web servers 102, file transfer protocol servers 103 and other network data servers 104.

FIG. 11 shows various incentives 105 that can be provided to a user for downloading data from interactive content cache server 42. Wireless operators can provide monetary incentives 106 by directly giving cash or cash rebates to users. Examples of monetary incentives 106 can be a fixed amount reduction in the monthly bill, coupons to purchase new equipment, addition of voice minutes and similar schemes that directly impact user 39. Another example of incentive 105 could be redeemable point incentives 107 based schemes that are redeemable at merchant stores. Another incentive maybe publicity incentive 108, that indicates editorial capabilities of individual users to other users so that some users can have followers for their editorial comments and content about cached content at interactive content cache server 42.

FIG. 12 shows unicast data distribution system 109. In unicast data distribution system 109, data is distributed as a unicast stream that is a one-to-one connection from mobile device 32 to interactive content cache server 42 through base transceiver station 33 and base station controller 35.

Each mobile device 32 that connects to interactive content cache server 42 using unicast data distribution system 109 has to setup an independent data stream even in the air interface and all the way till interactive content cache server 42. This results in low bandwidth efficiency at air interface. In this figure each of the independent air interface data streams is shown as a channel number such as channel one 110, channel two 111, and channel three 112.

For example, if there are five mobile devices 32 all receiving one mega bits per second data streams, then the bandwidth consumption from all those mobile devices 32 would be five mega bits per second.

FIG. 13 shows multicast data distribution system 113. In multicast data distribution system 113, data is distributed as a multicast stream that is a one-to-many connection from interactive content cache server 42 to several mobile devices 32 through base transceiver station 33 and base station controller 35.

Each mobile device 32 that connects to interactive content cache server 42 using multicast data distribution system 113 does not have to setup an independent data stream in the air interface or other network nodes till interactive content cache server 42. But in this system mobile device 32 shares air interface bandwidth with other mobile devices 32 in the same cell site. This results in high bandwidth efficiency at air interface and other networks nodes till interactive content cache server 42. In this figure all air interface data streams are shown as a single channel number such as channel one 110.

For example, if there are five mobile devices 32 all receiving one mega bits per second data streams, then the bandwidth consumption from all those mobile devices 32 would only be one mega bits per second in this data distribution system.

Multicast offers savings on bandwidth and is the preferred way of data distribution when data is transmitted to a set of mobile devices 32 in the same cell site. This is because a set of users can subscribe to the same data content to be downloaded at a pre defined date and time.

FIG. 14 is a flow chart illustrating the method that provides bandwidth optimization by enabling view of meta data 47 at interactive content cache server 42. In step 114, a request is sent from mobile device 32 to base station controller 35 to get meta data 47 associated with attached interactive content cache server 42.

In step 115, the meta data 47 is viewed at mobile device 32.

In step 116, based on meta data 47 information at mobile device 32, a list of data to be downloaded from interactive content cache server 42 is created.

In step 117, the list of data to be downloaded from mobile device 32 is uploaded to interactive content cache server 42.

In step 118, data requested in list of data to be downloaded from interactive content cache server 42 is sent to mobile device 32.

In step 119, at network node, user downloaded content at interactive content cache server 42 is cached to form new meta data 47.

### Advantages

From the description above a number of advantages of this interactive radio system become evident:
a) a bandwidth optimization system is provided that enables saving bandwidth in both backhaul and air interface;
b) a bandwidth optimization system is provided that provides a reasonable user experience in regards to delivering personalized content;
c) a bandwidth optimization system is provided that scales with user demand; and
d) a bandwidth optimization system is provided that uses social networking concepts to better utilize the available bandwidth.

### CONCLUSION, RAMIFICATIONS AND SCOPE

Accordingly, the reader will see that organizing cache content at base station controller and enabling users to view previously downloaded content or content that is to be downloaded later and providing incentives to users to use organized content in a interactive content cache server provides an unobvious result of reducing bandwidth usage both in backhaul network and the air interface.

Although the description above contains many specificities, these should not be construed as limiting the scope of invention but merely as providing illustrations of some of the presently preferred embodiments of this invention. Thus the scope of this invention should be determined by appended claims and their legal equivalents, rather than by example given.

We claim:

1. A bandwidth optimization system to reduce bandwidth usage of a cellular data network, comprising:
a interactive content cache server communicatively coupled to a network node of said cellular data network;
said interactive content cache server comprising data caching module to enable caching data downloaded by users from content servers associated with said cellular data network;
said interactive content cache server further comprising a data organization module that produces organized data and meta data corresponding to cached data produced at said data caching module;
said interactive content cache server further comprising data viewing and interaction module to export and enable interaction with selective views of said organized data and said meta data;
a mobile device used by said user for communicating with said interactive content cache server to display and interact with said organized data and said meta data; and
said content server that is a source of content data associated with said cellular data network.

2. The bandwidth optimization system of claim 1, wherein, said network node is selected from group consisting of base transceiver station, base station controller, and mobile switching center.

3. The bandwidth optimization system of claim 1, wherein, said content server is selected from group consisting of web server, ftp server, and other network data server.

4. The bandwidth optimization system of claim 1, wherein, said selective view is selected from group consisting of view of previously downloaded data at said interactive content cache server, view of data being currently downloaded at said interactive content cache server, and view of data that is scheduled for later download at said interactive content cache server.

5. The bandwidth optimization system of claim 1, wherein, said interactive content cache server is further comprised of:
data distribution module that enables data distribution of said organized data and said meta data using methods selected from group consisting of unicast data distribution method, and multicast data distribution method.

6. The bandwidth optimization system of claim 1, wherein said meta data information about said data is selected from group consisting of data category information, data time) of download information, data size information, data user ratings information, data creation timestamp information, data availability duration information, data download pricing information, base station controller associated with said data information, base transceiver station associated with said data information, data downloaded state information, data downloading state information, data scheduled for future download information, number of users interested in data information, and data user comments information.

7. A method to provide bandwidth optimization to a cellular data network comprising:
requesting from a mobile device a view of meta data associated with data at a interactive content cache server that is associated with a network node at said cellular data network;
receiving said view of meta data at said mobile device;
selecting a list of data to be downloaded from said view of meta data to form a list of selected data to be downloaded at said mobile device;
uploading said list from said mobile device to said interactive content cache server to request download of said selected data; and
downloading said selected data to said mobile device based on said list,
wherein said interactive content cache server caches user downloaded content from content servers associated with said cellular data network.

8. The method to provide bandwidth optimization to cellular data of claim 7, wherein said meta data information is selected from group consisting of data category information, data time of download information, data size information, data user ratings information, data creation timestamp information, data availability duration information, data download pricing information, base station controller associated with said data information, base transceiver station associated with said data information, data downloaded state information, data downloading state information, data scheduled for future download information, number of users interested in data information, and data user comments.

9. The method to provide bandwidth optimization to cellular data of claim 7, further comprising: organizing data downloaded into said interactive content cache server such that meta data information about all of said downloaded data is viewable by said user at said mobile device.

10. The method to provide bandwidth optimization to cellular data of claim 7, wherein said downloading of said data into said mobile device is implemented using data download method selected from unicast data download method, multicast data download method, synchronous data download method, and asynchronous data download method.

11. The method to provide bandwidth optimization to cellular data of claim 7, further comprising: selecting data by said user at said mobile device that is most related to data of interest to said user for said downloading in said list.

12. The method to provide bandwidth optimization to cellular data of claim 7, further comprising: providing incentives to said users to download said data associated with said interactive content cache server wherein said incentive is selected from group consisting of monetary incentive, redeemable points incentive, and publicity incentive.

13. The method to provide bandwidth optimization to cellular data of claim 7, further comprising: setting up a wish list of downloads at said interactive content cache server by said user, such that other users can add themselves to said wish list so that cost of downloading contents of said wish list is divided among all said wish list participant users.

14. The method to provide bandwidth optimization to cellular data of claim 13, further comprising: joining said wish list of another user based on common attributes related to download items in said wish list of another user.

15. The method to provide bandwidth optimization to cellular data of claim 13, wherein, said common attribute is selected from said meta data.

16. The method to provide bandwidth optimization to cellular data of claim 7, further comprising: voting up or down downloadable items in said selected data by said user to enable prioritizing data downloads.

17. The method to provide bandwidth optimization to cellular data of claim 7, further comprising: updating said user comments of said meta data information at said interactive content cache server with comments generated by said user of said mobile device.

18. A interactive content cache server apparatus associated with a cellular data network comprising:
a content caching module that enables caching content downloaded by users of mobile devices associated with said cellular data network from content servers associated with said cellular data network;
a content organizing module that produces organized data such that meta data about all downloaded content and corresponding content may be viewed by said users; and
a content viewing and interaction module that enables said users to view and interact with said organized data and said meta data.

19. The interactive content cache server apparatus of claim 18, wherein said association between said interactive content cache server with said cellular data network is at a network node selected from group consisting of base transceiver station, base station controller, and mobile switching center.

20. The interactive content cache server apparatus of claim 18, wherein, said interactive content cache server is further comprised of:
data distribution module that enables data distribution of said organized data using data download method selected from group consisting of unicast data download method, multicast data download method, synchronous data download method, and asynchronous data download method.
